(19) United States
(12) Patent Application Publication
(10) Pub. No.: US 2024/0152134 A1
(43) Pub. Date: May 9, 2024

(54) Isolation of Emergency within Process Systems of a Hydrocarbon Processing Facility

(71) Applicant: Saudi Arabian Oil Company, Dhahran (SA)

(72) Inventors: Yasser Alshaalan, Dammam (SA); Omar A. Dubayan, Dammam (SA); Omar A. Mohisin, Dammam (SA); Abdullah Ali Alghamdi, Dammam (SA); Haider Bashir, Abqaiq (SA)

(21) Appl. No.: 17/981,704

(22) Filed: Nov. 7, 2022

(51) Int. Cl. G05B 23/02

(52) U.S. Cl. CPC G05B 23/027; G05B 23/0272; G05B 2223/02; G05D 7/0676

(57) ABSTRACT

Example computer-implemented methods, media, and systems for isolating an emergency within process systems of a hydrocarbon processing facility are disclosed. One example method includes receiving a drawing of multiple process systems of a hydrocarbon processing facility. A respective identifier is assigned to each of multiple drawing vectors, where each of the multiple drawing vectors corresponds to a respective component of the multiple process systems. The multiple drawing vectors are coded based on the assigned identifiers. One or more drawing vectors connected to a location of the emergency are determined from the multiple coded drawing vectors. One or more connections between the one or more drawing vectors and the location of the emergency are identified. A first isolation valve for isolation of the emergency is determined from one or more isolation valves corresponding to the one or more connections. The first isolation valve is provided for the isolation of the emergency.

### TECHNICAL FIELD

The present disclosure relates to computer-implemented methods, media, and systems for isolating an emergency within process systems of a processing facility.

### BACKGROUND

During an emergency such as an upset, incident, or fire in a hydrocarbon processing facility, isolation of the emergency can be carried out by emergency shutdown systems (ESD) shutting down the processing facility or rely on operator training and knowledge to isolate the system from sources of energy, which may prolong or aggravate the emergency situation. The reliance on operator training and knowledge can also lead to human error as well as time delays in isolating the emergency.

### SUMMARY

The present disclosure involves computer-implemented methods, media, and systems for isolating an emergency within process systems of a hydrocarbon processing facility. One example computer-implemented method includes receiving a drawing of multiple process systems of a hydrocarbon processing facility. A respective identifier is assigned to each of multiple drawing vectors in the drawing, where each of the multiple drawing vectors corresponds to a respective component of the multiple process systems. The multiple drawing vectors are coded based on the assigned identifiers. A location of an emergency within the multiple process systems is received from a user. One or more drawing vectors that are connected to the location of the emergency are determined from the multiple coded drawing vectors. One or more connections between the one or more drawing vectors and the location of the emergency are identified, where each of the one or more connections has an isolation valve. A first isolation valve for isolation of the emergency is determined from the one or more isolation valves of the one or more connections. The determined first isolation valve is provided for the isolation of the emergency.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 illustrates an example flowchart of isolating an emergency within process systems of a hydrocarbon processing facility.

FIG. 2 illustrates an example phase separator.

FIG. 3 illustrates an example distillation column.

FIG. 4 illustrates an example code converted from drawing vectors.

FIG. 5 illustrates an example interactive graphical interface for isolating an emergency within process systems of a hydrocarbon processing facility.

FIG. 6 illustrates example coding of the process for isolating the emergency.

FIG. 7 illustrates an example process of isolating an emergency within process systems of a hydrocarbon processing facility.

FIG. 8 is a schematic illustration of example computer systems that can be used to execute implementations of the present disclosure.

Like reference numbers and designations in the various drawings indicate like elements.

### DETAILED DESCRIPTION

This specification relates to isolating an emergency within process systems of a hydrocarbon processing facility, using an automated and dynamic process that is based on converting drawing vectors of components of the process systems to code. A process system can be a system of one or more processes. In some implementations, live plant or process data are used during the isolation process. A graphical interface can be used to provide a highly granular visual representation of the process systems and the identified isolations. A logic based method can be used to identify the location of the emergency and assess isolation and associated impacts. The isolation process described in this specification can also be used to isolate an emergency within process systems of a processing facility other than hydrocarbon processing facilities, for example, a processing facility with multiple processes such as heating, cooling, or reacting processes. Examples of such processing facilities with multiple processes can include food or pharmaceutical processing facilities.

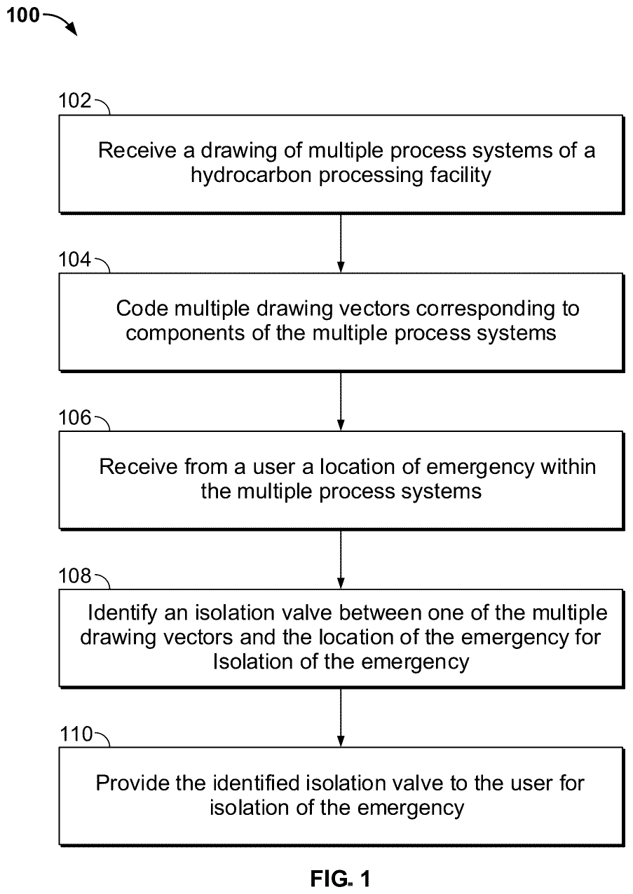

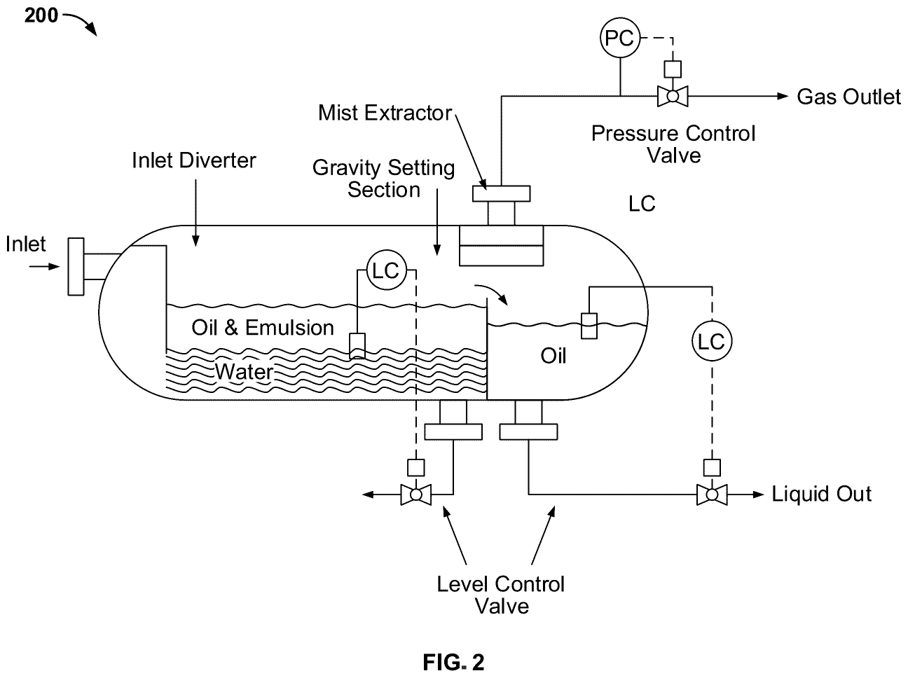

FIG. 1 illustrates an example flowchart 100 of isolating an emergency within process systems of a hydrocarbon processing facility.

At 102, a drawing of multiple process systems of a processing facility is received. In some implementations, the drawing represents all existing process systems of the processing facility. The drawing can include details that identify interlinks among the multiple process systems, available isolation valves within the multiple process systems, and as-built status of the multiple process systems in the field.

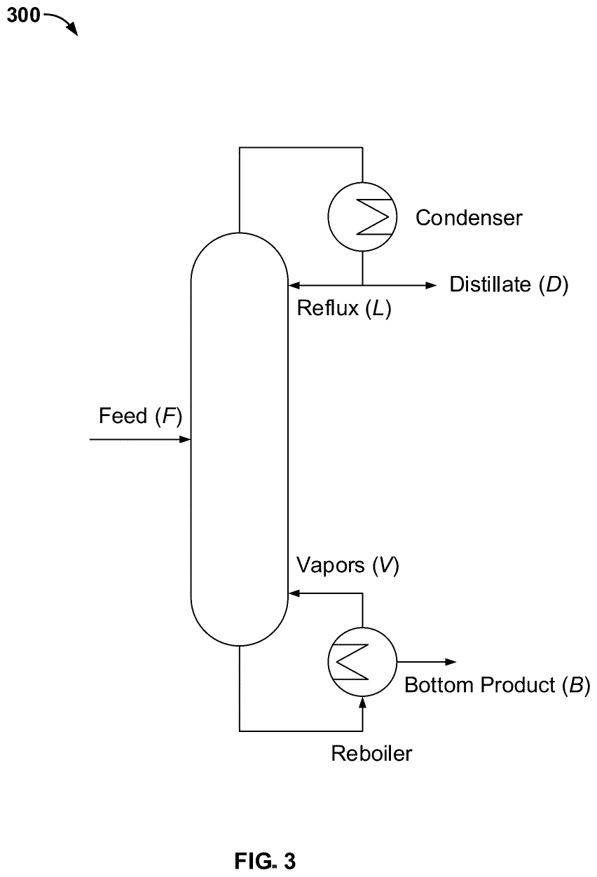

In some implementations, different process systems in the processing facility are interlinked through specific types of equipment, and therefore isolation of any one process system can affect the other process systems. Examples of processing facilities can include phase separators, distillation columns and heat exchangers. FIG. 2 illustrates an example phase separator 200, and FIG. 3 illustrates an example distillation column 300. Both processing facilities in FIG. 2 and FIG. 3 have the general structure of a bottom liquid product circuit, a top product or distillate circuit, a feed circuit, and a utility circuit for both the bottom heat provision and overhead cooling provision. Each of the aforementioned circuits can be a process system within the processing facility.

In some implementations, major equipment in a processing facility are connected to various process systems. Each process system can have its own isolations and the subsequent impacts of the isolations to other process systems connected to the process system. To determine isolation of an emergency, all connected process systems within the processing facility can be considered. The connected process systems are also called multiple layers. One example of a processing facility having multiple layers is a degassing column. The base layer is the crude oil system, where the bulk of the fluid passing through the equipment. The next layer is the gas system, since some of the oil is vaporized and routed to the gas processing facilities. The third layer is the utility layer, which is a steam system in the case of a degassing column. Another example of a processing facility is a crude distillation column or a fractionator in a refinery that can include a crude preheat train, a naphtha circuit, a kerosene circuit, and a diesel circuit.

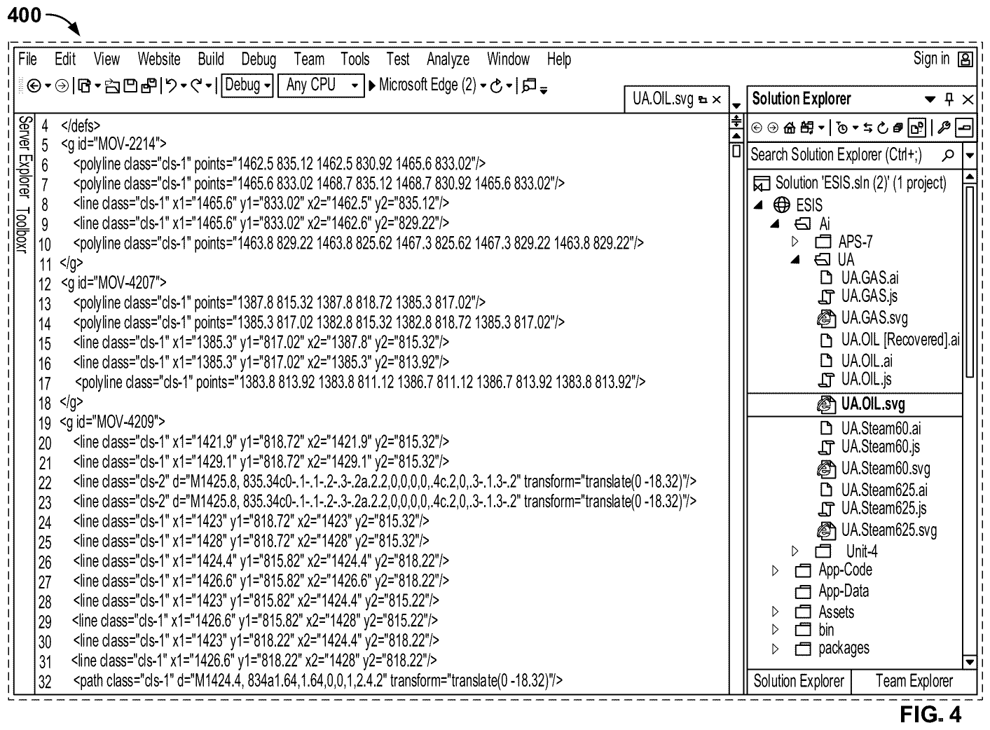

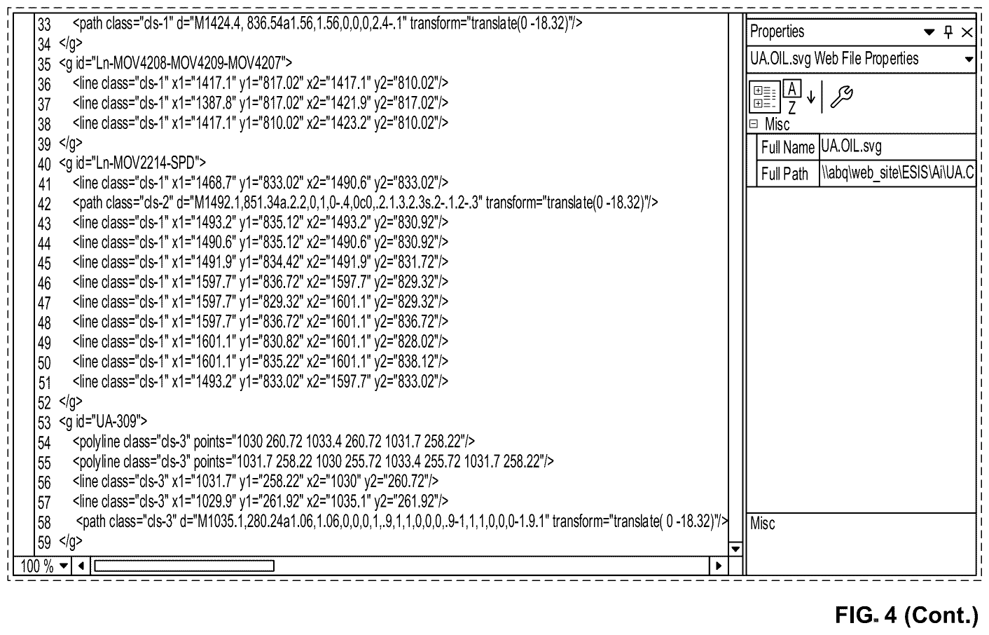

At 104, multiple drawing vectors corresponding to components of the multiple process systems are coded. The conversion of drawing vectors to code can help identify the location of the emergency in the drawing as well as the drawing vectors connected to the location of the emergency, when a user selects a location of an emergency. The coding of the multiple drawing vectors can also help determining which process systems in a processing facility are affected. This can be done by identifying nodes where different process systems intersect. For example, in FIG. 3 the column can be designated as a node and therefore if a leak is identified near the column the pre-programmed logic can recognize this node and cascade the isolation detection to the other related systems. In some implementations, unique identifiers for all components (drawing vectors) of the drawing are assigned and converted to code for the logic based algorithm to utilize in identification of isolation and associated impacts. An example code converted from drawing vectors is illustrated in FIG. 4.

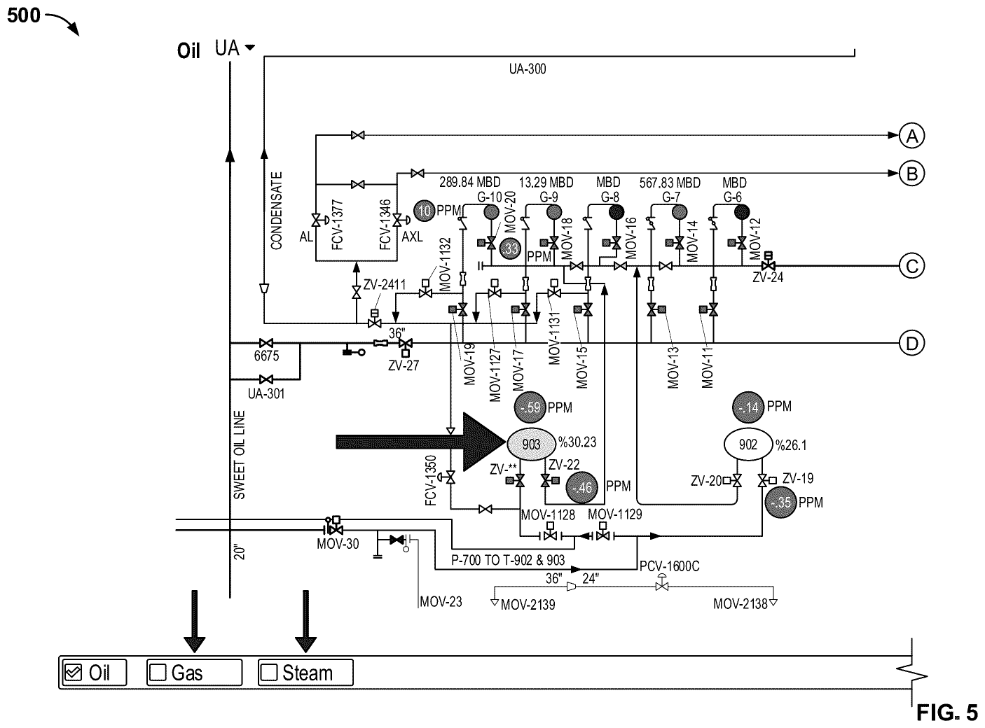

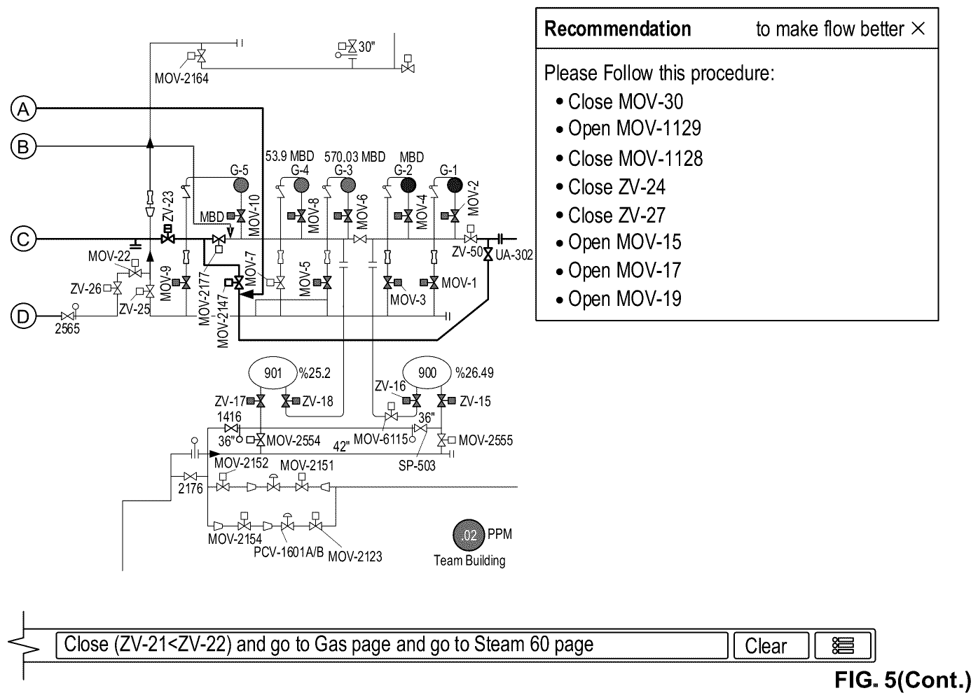

At 106, a location of emergency within the multiple process systems is provided by a user. In some implementations, an interactive graphical interface can be used for the user to select location of an emergency and see the impact of the emergency on all affected process systems as well as the isolations identified based on the location of the emergency. The graphical interface can be developed utilizing commercially available software and integrated development environments such as Adobe Illustrator® and Microsoft Visual Studio®. For example, features in Adobe Illustrator® can be enabled to code drawing vectors so that process parameters along with operation methodology can be recognized in order to improve the isolation procedure for the operators. Moreover, Adobe Illustrator® can be used to rearrange and group drawing vectors based on components of the multiple process systems and the flow in or between the components. The rearranged and grouped drawing vectors can be saved in vector graphics format such as SVG extension. The name and classes of the drawing vectors in vector graphics format can then be used for coding the drawing vectors in order to define the drawing vectors. FIG. 5 illustrates an example interactive graphical interface 500 isolating an emergency within process systems of a hydrocarbon processing facility. Major components of the graphical interface can include major equipment in the processing facility, lines showing the major connections to each equipment, isolation valves within the multiple process systems, and status indication for valves, pumps, and gas detectors.

In some implementations, once the user selects the emergency location, the location can be highlighted, and the identified isolations can be highlighted on the interface. Furthermore to facilitate emergency response, the identified isolations can also be listed as text to allow a checklist clearance to be carried out. The list can be used to account for human factors since in a high stress emergency situation, all information on a complex drawing may not be digested quickly. The interface can also list the other process systems affected and provide links to see those system drawings with associated isolations.

At 108, an isolation valve between one of the multiple drawing vectors and the location of the emergency is identified for isolation of the emergency. In some implementations, pertinent data for identifying isolation of the emergency is collected and integrated to show a live condition of the multiple process systems. Features and functions of the collected data can include: (1) Safe atmosphere detection (SAD) to determine whether the atmosphere local to the emergency is safe for performing isolation based on field detectors as well as wind direction to determine if certain isolations need to be modified or approached from a particular direction. (2) Isolation difficulty adjustment (IDA) that identifies if a particular isolation is challenging and proposes the next most suitable option. One example is that a large bore manual valve that may require a lot of time and manual intervention to close, and a faster alternative can be an actuated valve further away from the emergency. This provides a quick course of action. (3) Error minimization function (EMF) that verifies process parameters are healthy and are within prescribed design ranges so that erroneous isolations and impacts are not identified or utilized. Examples of this can include any transmitter providing bad present value input due to a field instrument fault is ignored. Similarly, various process parameters can be assigned ranges so that the process parameters can be sensible and logical. An example is checking the flow reading in a line, verifying the control valve opening line as well as line pressure to confirm there is flow in the system. For example, if a flow reading is shown but there is no pressure and the valves into the system are closed, then the flow reading can be erroneous and therefore the other isolation valves can be considered for isolating the emergency. Similar checks can be carried out so that the isolation targets the live process systems connected to the equipment under emergency. Other process parameters for verification can include line temperature, limit switch output, position transmitter output, or electrical run status of a motor drive.

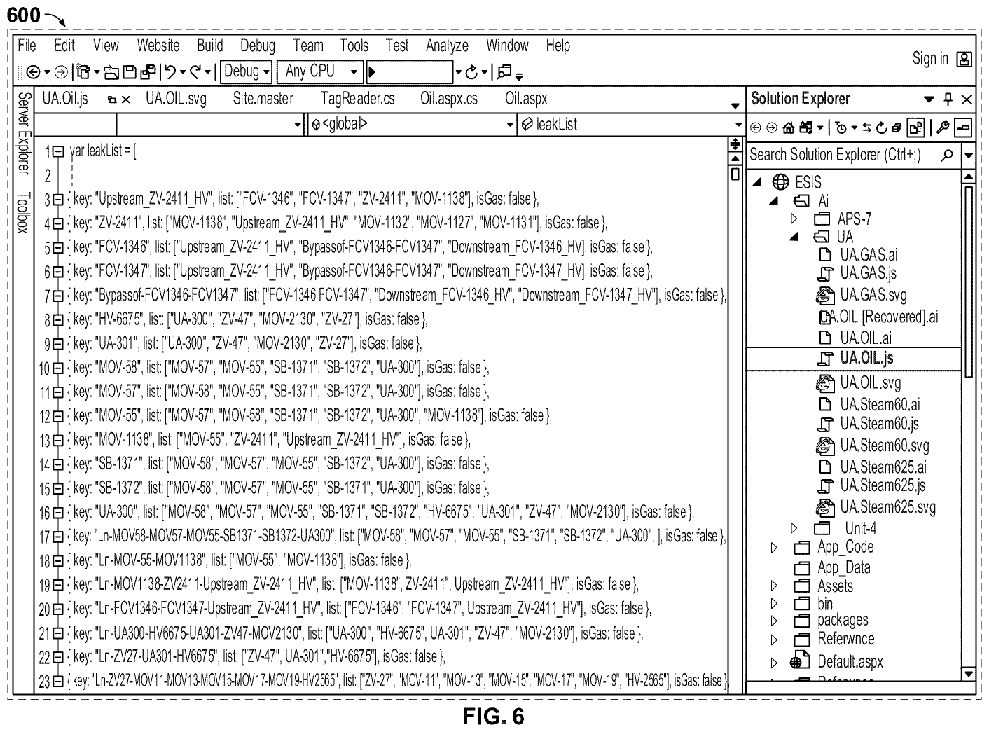

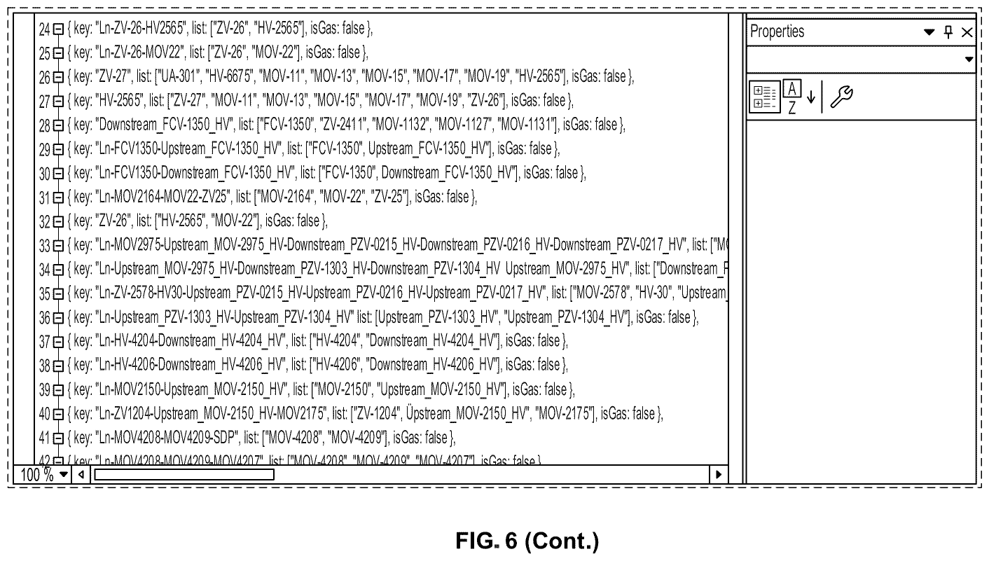

In some implementations, connections between drawing vectors and the location of emergency are identified and checked for process parameters, available isolation valves and the status of the available isolation valves. For those process systems identified as live and with available isolations, the available isolations, for example, the available isolation valves, can be further ranked by ease of operation so that an actuated valve is preferred to a manual value, and gas detection feedback and wind direction can be taken into account during the ranking process. Then the isolation is identified based on the result of the ranking process. FIG. 6 illustrates example coding 600 of the process for isolating the emergency.

In some implementations, the aforementioned method can also be applied to all utility sub-systems (steam, water, and fuel gas) and generate a recommendation of which utility sub-system can be isolated, based on the nature of the emergency (e.g., vertical assessment and linkage). More specifically, once the user selects the location of the emergency, the utility sub-systems that are related to the emergency can be identified. This identification is again carried out through the drawing vectors converted to code. In the example illustrated in FIG. 6, if the reboiler is selected as the emergency location, then the steam source to the reboiler is identified as one of the layers of isolation and therefore the available isolation on that utility system is identified.

At 110, the identified isolation valve is provided to the user for isolation of the emergency. In some implementations, after the user isolates the emergency based on the identified isolation valve, the drawing of multiple process systems can be updated to indicate that a drawing vector associated with the identified isolation valve is in a closed status. The indication of the closed status of the drawing vector associated with the identified isolation valve can be done using a filed limit switch in the drawing.

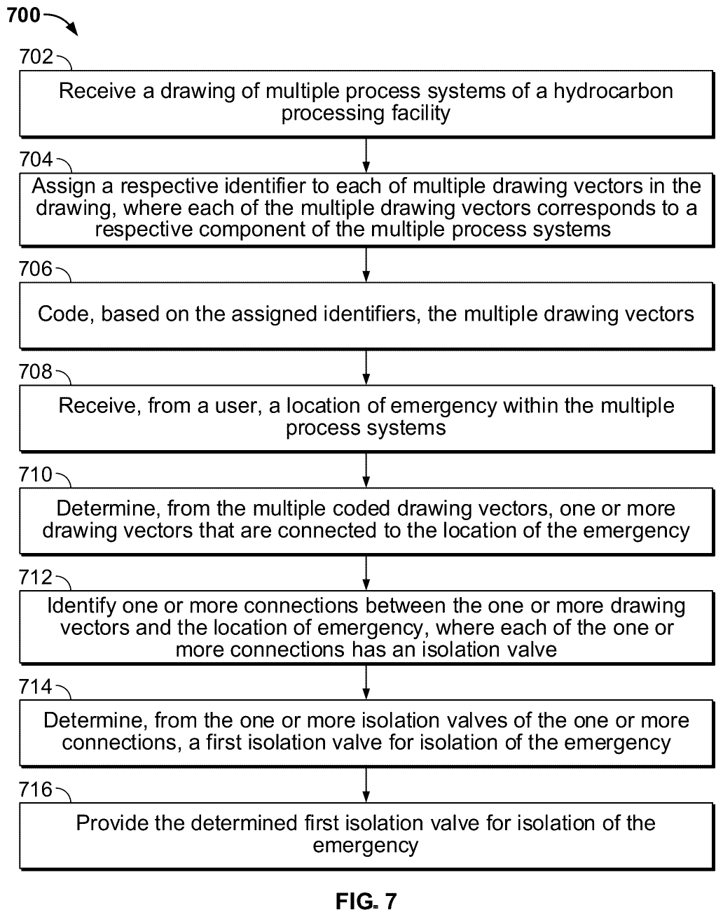

FIG. 7 illustrates an example process 700 of isolating an emergency within process systems of a hydrocarbon processing facility. For convenience, the process 700 will be described as being performed by a system of one or more computers, located in one or more locations, and programmed appropriately in accordance with this specification.

At 702, a computer system receives a drawing of multiple process systems of a hydrocarbon processing facility.

At 704, the computer system assigns a respective identifier to each of multiple drawing vectors in the drawing, where each of the multiple drawing vectors corresponds to a respective component of the multiple process systems.

At 706, the computer system codes, based on the assigned identifiers, the multiple drawing vectors.

At 708, the computer system receives, from a user, a location of emergency within the multiple process systems.

At 710, the computer system determines, from the multiple coded drawing vectors, one or more drawing vectors that are connected to the location of the emergency.

At 712, the computer system identifies one or more connections between the one or more drawing vectors and the location of emergency, where each of the one or more connections has an isolation valve.

At 714, the computer system determines, from the one or more isolation valves of the one or more connections, a first isolation valve for isolation of the emergency.

At 716, the computer system provides the determined first isolation valve for isolation of the emergency.

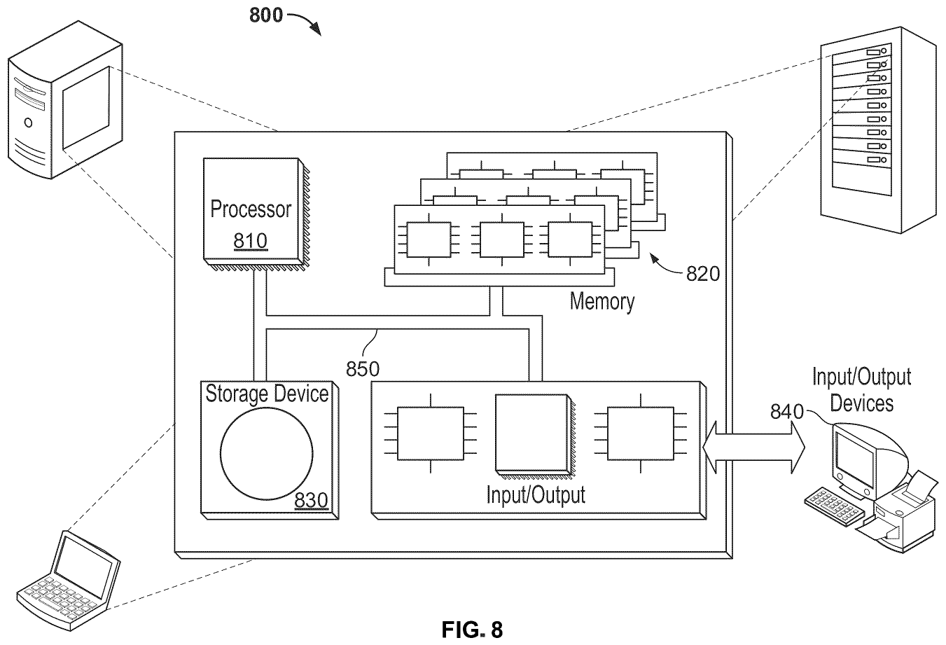

FIG. 8 illustrates a schematic diagram of an example computing system 800. The system 800 can be used for the operations described in association with the implementations described herein. For example, the system 800 may be included in any or all of the server components discussed herein. The system 800 includes a processor 810, a memory 820, a storage device 830, and an input/output device 840. The components 810, 820, 830, and 840 are interconnected using a system bus 850. The processor 810 is capable of processing instructions for execution within the system 800. In some implementations, the processor 810 is a single-threaded processor. The processor 810 is a multi-threaded processor. The processor 810 is capable of processing instructions stored in the memory 820 or on the storage device 830 to display graphical information for a user interface on the input/output device 840.

The memory 820 stores information within the system 800. In some implementations, the memory 820 is a computer-readable medium. The memory 820 is a volatile memory unit. The memory 820 is a non-volatile memory unit. The storage device 830 is capable of providing mass storage for the system 800. The storage device 830 is a computer-readable medium. The storage device 830 may be a floppy disk device, a hard disk device, an optical disk device, or a tape device. The input/output device 840 provides input/output operations for the system 800. The input/output device 840 includes a keyboard and/or pointing device. The input/output device 840 includes a display unit for displaying graphical user interfaces.

Certain aspects of the subject matter described here can be implemented as a method. A drawing of multiple process systems of a hydrocarbon processing facility is received. A respective identifier is assigned to each of multiple drawing vectors in the drawing, where each of the multiple drawing vectors corresponds to a respective component of the multiple process systems. The multiple drawing vectors are coded based on the assigned identifiers. A location of an emergency within the multiple process systems is received from a user. One or more drawing vectors that are connected to the location of the emergency are determined from the multiple coded drawing vectors. One or more connections between the one or more drawing vectors and the location of the emergency are identified, where each of the one or more connections has an isolation valve. A first isolation valve for isolation of the emergency is determined from the one or more isolation valves of the one or more connections. The determined first isolation valve is provided for the isolation of the emergency.

An aspect taken alone or combinable with any other aspect includes the following features. Coding the multiple drawing vectors includes coding the multiple drawing vectors using a vector graphics editor.

An aspect taken alone or combinable with any other aspect includes the following features. Receiving the location of the emergency within the multiple process systems includes receiving, based on an input from the user to a graphical interface, the location of the emergency within the multiple process systems.

An aspect taken alone or combinable with any other aspect includes the following features. Determining the first isolation valve for the isolation of the emergency includes ranking the one or more connections based on at least one of a time period for closing the respective isolation valve, a wind direction local to the location of the emergency, or one or more process parameters for each of the one or more connections, and the one or more process parameters for each of the one or more connections include at least one of a flow reading, a line pressure, a line temperature, a limit switch output, a position transmitter output, or an electrical run status of a motor drive.

An aspect taken alone or combinable with any other aspect includes the following features. Determining the first isolation valve for the isolation of the emergency includes determining that there is a line pressure for a connection associated with the first isolation valve.

An aspect taken alone or combinable with any other aspect includes the following features. Two or more process systems of the multiple of process systems are connected.

An aspect taken alone or combinable with any other aspect includes the following features. One or more process systems that are affected by the emergency are determined based on the multiple coded drawing vectors, where the one or more process systems are part of the multiple process systems.

An aspect taken alone or combinable with any other aspect includes the following features. After the determined first isolation valve for the isolation of the emergency is provided, the drawing of the multiple process systems is updated to indicate, using a filed limit switch in the drawing, that a drawing vector associated with the determined first isolation valve is in a closed status.

Certain aspects of the subject matter described in this disclosure can be implemented as a non-transitory computer-readable medium storing instructions which, when executed by a hardware-based processor perform operations including the methods described here.

Certain aspects of the subject matter described in this disclosure can be implemented as a computer-implemented system that includes one or more processors including a hardware-based processor, and a memory storage including a non-transitory computer-readable medium storing instructions which, when executed by the one or more processors performs operations including the methods described here.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A computer-implemented method, comprising:
receiving a drawing of a plurality of process systems of a hydrocarbon processing facility;
assigning a respective identifier to each of a plurality of drawing vectors in the drawing, wherein each of the plurality of drawing vectors corresponds to a respective component of the plurality of process systems;
coding, based on the assigned identifiers, the plurality of drawing vectors;
receiving, from a user, a location of an emergency within the plurality of process systems;
determining, from the plurality of coded drawing vectors, one or more drawing vectors that are connected to the location of the emergency;
identifying one or more connections between the one or more drawing vectors and the location of the emergency, wherein each of the one or more connections has an isolation valve;
determining, from the one or more isolation valves of the one or more connections, a first isolation valve for isolation of the emergency; and
providing the determined first isolation valve for the isolation of the emergency.

2. The computer-implemented method of claim 1, wherein coding the plurality of drawing vectors comprises coding the plurality of drawing vectors using a vector graphics editor.

3. The computer-implemented method of claim 1, wherein receiving the location of the emergency within the plurality of process systems comprises receiving, based on an input from the user to a graphical interface, the location of the emergency within the plurality of process systems.

4. The computer-implemented method of claim 1, wherein determining the first isolation valve for the isolation of the emergency comprises ranking the one or more connections based on at least one of a time period for closing the respective isolation valve, a wind direction local to the location of the emergency, or one or more process parameters for each of the one or more connections, and wherein the one or more process parameters for each of the one or more connections comprise at least one of a flow reading, a line pressure, a line temperature, a limit switch output, a position transmitter output, or an electrical run status of a motor drive.

5. The computer-implemented method of claim 1, wherein determining the first isolation valve for the isolation of the emergency comprises determining that there is a line pressure for a connection associated with the first isolation valve.

6. The computer-implemented method of claim 1, wherein two or more process systems of the plurality of process systems are connected.

7. The computer-implemented method of claim 1, further comprising:
determining, based on the plurality of coded drawing vectors, one or more process systems that are affected by the emergency, wherein the one or more process systems are part of the plurality of process systems.

8. The computer-implemented method of claim 1, wherein after providing the determined first isolation valve for the isolation of the emergency, the method further comprises:
updating the drawing of the plurality of process systems by indicating, using a filed limit switch in the drawing, that a drawing vector associated with the determined first isolation valve is in a closed status.

9. A non-transitory, computer-readable medium storing one or more instructions executable by a computer system to perform operations comprising:
receiving a drawing of a plurality of process systems of a hydrocarbon processing facility;
assigning a respective identifier to each of a plurality of drawing vectors in the drawing, wherein each of the plurality of drawing vectors corresponds to a respective component of the plurality of process systems;
coding, based on the assigned identifiers, the plurality of drawing vectors;
receiving, from a user, a location of an emergency within the plurality of process systems;
determining, from the plurality of coded drawing vectors, one or more drawing vectors that are connected to the location of the emergency;
identifying one or more connections between the one or more drawing vectors and the location of the emergency, wherein each of the one or more connections has an isolation valve;
determining, from the one or more isolation valves of the one or more connections, a first isolation valve for isolation of the emergency; and
providing the determined first isolation valve for the isolation of the emergency.

10. The non-transitory, computer-readable medium of claim 9, wherein coding the plurality of drawing vectors comprises coding the plurality of drawing vectors using a vector graphics editor.

11. The non-transitory, computer-readable medium of claim 9, wherein receiving the location of the emergency within the plurality of process systems comprises receiving, based on an input from the user to a graphical interface, the location of the emergency within the plurality of process systems.

12. The non-transitory, computer-readable medium of claim 9, wherein determining the first isolation valve for the isolation of the emergency comprises ranking the one or more connections based on at least one of a time period for closing the respective isolation valve, a wind direction local to the location of the emergency, or one or more process parameters for each of the one or more connections, and wherein the one or more process parameters for each of the one or more connections comprise at least one of a flow reading, a line pressure, a line temperature, a limit switch output, a position transmitter output, or an electrical run status of a motor drive.

13. The non-transitory, computer-readable medium of claim 9, wherein determining the first isolation valve for the isolation of the emergency comprises determining that there is a line pressure for a connection associated with the first isolation valve.

14. The non-transitory, computer-readable medium of claim 9, wherein two or more process systems of the plurality of process systems are connected.

15. The non-transitory, computer-readable medium of claim 9, wherein after providing the determined first isolation valve for the isolation of the emergency, the operations further comprise:
updating the drawing of the plurality of process systems by indicating, using a filed limit switch in the drawing, that a drawing vector associated with the determined first isolation valve is in a closed status.

16. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations comprising:
receiving a drawing of a plurality of process systems of a hydrocarbon processing facility;
assigning a respective identifier to each of a plurality of drawing vectors in the drawing, wherein each of the plurality of drawing vectors corresponds to a respective component of the plurality of process systems;
coding, based on the assigned identifiers, the plurality of drawing vectors;
receiving, from a user, a location of an emergency within the plurality of process systems;
determining, from the plurality of coded drawing vectors, one or more drawing vectors that are connected to the location of the emergency;
identifying one or more connections between the one or more drawing vectors and the location of the emergency, wherein each of the one or more connections has an isolation valve;
determining, from the one or more isolation valves of the one or more connections, a first isolation valve for isolation of the emergency; and
providing the determined first isolation valve for the isolation of the emergency.

17. The computer-implemented system of claim 16, wherein coding the plurality of drawing vectors comprises coding the plurality of drawing vectors using a vector graphics editor.

18. The computer-implemented system of claim 16, wherein determining the first isolation valve for the isolation of the emergency comprises ranking the one or more connections based on at least one of a time period for closing the respective isolation valve, a wind direction local to the location of the emergency, or one or more process parameters for each of the one or more connections, and wherein the one or more process parameters for each of the one or more connections comprise at least one of a flow reading, a line pressure, a line temperature, a limit switch output, a position transmitter output, or an electrical run status of a motor drive.

19. The computer-implemented system of claim 16, wherein determining the first isolation valve for the isolation of the emergency comprises determining that there is a line pressure for a connection associated with the first isolation valve.

20. The computer-implemented system of claim 16, wherein after providing the determined first isolation valve for the isolation of the emergency, the one or more operations further comprise:
updating the drawing of the plurality of process systems by indicating, using a filed limit switch in the drawing, that a drawing vector associated with the determined first isolation valve is in a closed status.
